(19) United States
(12) Patent Application Publication
(10) Pub. No.: US 2008/0085066 A1
(43) Pub. Date: Apr. 10, 2008

(54) Package Applications Using Polylactic Acid Film

(76) Inventors: Kevin J. Curie, Appleton, WI (US); Robert J. Blemberg, Appleton, WI (US); Brian K. Muehl, Sherwood, WI (US); Robert W. Knoll, Neenah, WI (US)

Correspondence Address: BANNER & WITCOFF, LTD., TEN SOUTH WACKER DRIVE, SUITE 3000, CHICAGO, IL, 60606, US

(21) Appl. No.: 11/769,777

(22) Filed: Jun. 28, 2007

Related U.S. Application Data
(60) Provisional application No. 60/849,779, filed on Oct. 6, 2006.

(51) Int. Cl. B65D 33/16; B29C 47/00

(52) U.S. Cl. 383/61.2; 264/176.1; 383/61.1; 383/61.3

(57) ABSTRACT

Fresh produce and cut flower packages are prepared from one or more polymer layers. At least one layer is a polylactic acid (PLA) film layer. Layers that can be adhered to the PLA film layer include polyolefin and polyester films. The packages have optimized moisture vapour transmission rates (MVTR) and oxygen transmission rates (OTR) to produce a shelf-life extended package that reduces growth of bacteria and prevents haze or fog on the inside of the package.

### FIELD OF THE INVENTION

Illustrative aspects of the invention relate to flexible plastic packaging for perishable items such as, but not limited to, fresh produce and fresh-cut flowers.

### BACKGROUND

Existing fresh produce packages are typically made of polyolefin flexible film materials (low density polyethylene (LDPE), oriented polypropylene (OPP), etc.), converted into simple bags by folding and heat-sealing films of the appropriate size and shape. A typical finished bag is approximately 28 cm long by 23 cm wide, containing heat-sealed seams at the bottom, top, and vertically along the back (fin seam). The bags may be composed of monolayer or multilayer films. Desired package characteristics include flexibility, economy, food compatibility, OTR and MVTR levels (respiration), mechanical durability to withstand normal handling, printability, and high transparency necessary to display the contents. Produce bags also require relatively high oxygen permeabilites, and water vapor transmission rates (WVTR) suited to the product.

During refrigerated storage of normally moist fresh-produce such as lettuce or spinach, moisture droplets tend to condense on the interior surface of conventional polyolefin produce bags, creating haze and reducing transparency, thereby obscuring the contents of the package. Retail sellers and consumers of fresh, normally moist, produce, such as chopped lettuce, spinach, and salad mix, prefer transparent plastic packaging that does not “fog up” during refrigerated storage in retail store display cases. Moreover, retailers require a certain shelf life for the products sold.

Packaging manufacturers minimize or reduce fogging by incorporating an “anti-fog” additive into the plastic, or by coating the interior surface with an anti-fog chemical coating to reduce fogging or to improve transparency. Such substances modify the surface energy of the film and prevent haze formation. However, these substances add to the package cost and complexity and are not always effective.

Similar concerns are present for packaging of plants such as fresh cut flowers. Retailers and consumers desire film materials that provide Desired package characteristics include flexibility, economy, OTR and MVTR levels (respiration), mechanical durability to withstand normal handling, printability, and high transparency necessary to display the contents. Plant bags also require relatively high oxygen permeabilites, and moisture vapor transmission rates (MVTR) suited to the product.

Finally, with any packaging material, it is desired to provide packaging that is considered to be sustainable according to certain standards, and which therefore has minimal impact on the environment. There is a demand and preference from certain retailers and retail customers for sustainable packaging. Sustainable packaging is defined by a number of criteria, two of which are biodegradability, and the use of renewable feedstocks or renewable source materials to produce the packaging materials. PLA and other bio-resins meet these criteria because they are biodegradable per ASTM standard D6400, and are made from plant-based renewable feedstocks (e.g., corn starch for PLA). In contrast, traditional polymers such as polyolefins and OPET are made from non renewable fossil fuels (oil and natural gas), and are typically not biodegradable. Organic materials (e.g. polymeric plastics) produced from renewable or plant-based substances are said to have a smaller “carbon footprint” than polymers made from fossil fuel feedstocks. Hybrid packaging structures such as the multilayer laminated films described herein can partially satisfy sustainability criteria even though these structures are not entirely biodegradable or made entirely of renewable materials. From a sustainability viewpoint, they have the advantage of a smaller carbon footprint than packaging made entirely from traditional fossil-fuel feedstocks.

### SUMMARY

Aspects of the invention are directed to polylactic acid film laminations having at least one polylactic acid layer useful for the packaging of perishable items. These laminations, including the PLA film, respire at different rates and ratios (MVTR/OTR ratio) than conventional laminations. The respiration can be optimized by choosing various polyolefin film layers and polyester film layers as the other polymer film layers within the laminate (OPET/PLA, PE/PLA, OPP/PLA, etc.) Packages prepared with the PLA film or laminate provide an extended shelf-life for perishable items over conventional packages. The laminations provide better heat stability and mechanical strength over PLA alone. Further laminations allow reverse printing or burying the print between the layers. Laminations can also provide enhanced barrier properties than PLA alone.

One aspect of the invention is directed to fresh produce packages prepared with a polylactic acid film. Another aspect is directed to fresh produce packages prepared from laminates wherein at least one layer of the laminate is a polylactic acid film and another polymer layer is a polyolefin film layer or a polyester film layer other than a polylactic acid film layer. The fresh produce packages are breathable allowing oxygen and moisture to respire through the package.

Another aspect of the invention is directed to plant or fresh cut flowers packages prepared from a polylactic acid film. Another aspect is directed to plant or fresh cut flower packages prepared from laminates wherein at least one layer of the laminate is a polylactic acid film and another polymer layer is a polyolefin film layer or a polyester film layer other than a polylactic acid film layer. The plant and flower packages are breathable through the packages.

Further aspects of the invention are directed to new sealing methods and seal materials used for the packages.

### DETAILED DESCRIPTION

Illustrative aspects of the present invention will be described. These aspects merely provide examples of the invention, and it is needless to say that the aspects can be suitably modified without departing from the gist of the invention.

Aspects of the invention include flexible packages (such as bags) for perishable items. Perishable items may be any item that needs to be preserved including, but not limited to, fresh produce such as fruits and vegetables, and fresh cut flowers.

The flexible packages are prepared from polylactic acid (PLA) film as the sole layer of a monolayer package or at least one layer of a multilayer package.

Polylactic acid (PLA) is a biodegradable polymer derived from lactic acid. It is a highly versatile material and is made from 100% renewable resources like corn, sugar beets, wheat and other starch-rich products. It can be easily produced in a high molecular weight form through ring-opening polymerization.

Polylactic acid exhibits some properties that are equivalent to or better than many petroleum-based plastics. Polylactic acid can be molded, vacuum formed, blown or cast.

PLA is biodegradable providing an advantage over conventional non-degradable polyolefin films and laminates. When ultimately disposed of in a landfill, the biodegradable nature of PLA films in composting conditions will cause the PLA film to biodegrade and deteriorate. Thus the packages are eco-friendly.

PLA produce packages may be produced in any suitable manner such as from blown PLA film. The films may be biaxially oriented or unoriented, for example. The film may be of any suitable thickness, and is typically 70 to 200 GA.

A PLA film or layer has natural anti-fog properties which reduces the need for anti-fog additives or coatings. These features provide an improved flexible package, for example to store fresh produce in refrigerated display cases in retail stores for ultimate purchase and use by consumers.

Packages containing PLA film layers have improved characteristics relative to conventional packages made from polyolefin film layers. In fact, it was discovered that packages including PLA films provide an unexpected increase in shelf life of the product, up to 1 to 2 weeks beyond the typical shelf life.

When packaged, fresh produce such as salad mix, diced lettuce, broccoli, beans, sprouts, herbs, or other produce, remains essentially clear during refrigerated storage. Fog may initially accumulate in PLA bags immediately after packing, but the bags clear up and remain clear after 4 to 6 hours whereas conventional bags may take several days.

Moreover, as mentioned above, the shelf life of the produce packaged in a PLA film bag is unexpectedly increased over conventional polyolefin bags up to 1 to 2 weeks. In addition, there are fewer microorganisms present in the bag when compared with conventional bags.

Fresh cut flowers packaged in PLA florist bags or wraps, for example, stay fresh longer than fresh cut flowers stored in conventional florist bags. Suitable bags or wraps may be of any suitable design as within the skill of the art.

Additional aspects of the invention relate to produce and plant packages made from multilayer films composed of at least one PLA layer laminated to at least one other layer composed of other materials such as, but not limited to, oriented polypropylene (OPP), oriented polyethylene terephthalate (OPET), polyethylene, high VA ethylene vinyl acetate (EVA), and starch-modified polyolefin films (e.g., transparent material from Novamont). In aspects of a produce package, the inner or food contact layer is the PLA layer. In aspects of a plant package, the inner or plant contact layer is the PLA layer. The materials are selected to optimize the oxygen transfer rate (OTR), the moisture vapor transfer rate (MVTR), and the OTR:MVTR ratios. The values for OTR and MVTR are dependent upon the polymers selected.

For example, if only PLA is used in the package, the MVTR can be about 5 to about 12 gms/24 hrs per 100 in² and the OTR can be about 15 to about 41 cc/24 hrs per 100 in². If OPET/PLA is used in the package, the MVTR can be about 0.5 to about 4 gms/24 hrs per 100 in² and the OTR can be about 6 to about 9 cc/24 hrs per 100 in². If OPP/PLA is used in the package, the MVTR can be about 0.1 to about 3 gms/24 hrs per 100 in and the OTR can be about 25 to about 35 cc/24 hrs per 100 in².

The use of the PLA layer/polymer layer (e.g. OPP, OPET, EVA, etc.) allows optimization of OTR and MVTR values and hence allows bags to be produced providing increased shelf life over conventional bags by 1-2 weeks. Shelf life is extended due to reducing the amount of fog and by controlling bacterial growth. Controlling the moisture in the bag prevents early onset of purge—the liquid obtained from decay of the produce in the bag.

The layers may be adhered to each other in any suitable manner such as by adhesive lamination. The laminate may use a water-based adhesive, a solvent-based adhesive, or a solvent-less adhesive.

The type of material and thickness (gauge) of the outer layer may be chosen to provide desired mechanical durability and to tailor the oxygen and water vapor transmission rates to increase shelf life and reduce fogging. Typical outer layer thicknesses are 36 to 120 GA.

The permeability of the multilayer package may be further adjusted by micro-perforating the package with arrays of small diameter holes by means of mechanical or laser methods. Such perforations can further optimize the OTR to MVTR ratio.

Other aspects of the invention include PLA produce and plant packages, monolayer or multilayer, having reclosable or “press-to-close” seals and/or zippers. The reclosable seal adds convenience compared to the permanent seals on current bags. The seal material may be any suitable cold seal coating such as top (openable) seal and bottom and fin seals.

The PLA mono-layer or lamination may be printed, for example with information regarding the contents of the packages or with a pattern or design.

The PLA film may further comprise an anti-fogging coating, if desired for enhanced performance. The anti-fog coating would prevent fog at “time zero.”

### EXAMPLE 1

Samples of PLA were used to test for anti-fog characteristics. Samples 1 through 4 were composed of oriented polypropylene (OPP) laminated with PLA. Samples 6-9 were PLA film samples. PLA samples were also prepared with OPET laminated with PLA. SKC 100 is oriented PLA film.

| Sample | PLA |
|---|---|
| 1 | Variable 1: 48 OPP - 100 PLA |
| 2 | Variable 2: 48 OPP - 120 PLA |
| 3 | Variable 3: 70 OPP - 100 PLA |
| 4 | Variable 3: 70 OPP - 120 PLA |
| 5 | OPLA |
| 6 | 100 GA PLA (unoriented) |
| 7 | 120 GA PLA (unoriented) |
| 8 | 200 GA PLA (unoriented) |
| 9 | 36 OPET - 100 PLA |
| 10 | 36 OPET - OPLA |

Squares of each sample were cut and placed on top of a 250 mL beaker filled with 200 mL of room temperature water (approximately 72° F.). The beakers were then put in a refrigerated room (35° F., 50% R.H.). The samples were observed at 4 hours, 24 hours, 3 days, and 7 days for fog.

For practical application tests, salad bag samples were made using an impulse sealer. The dimensions of the bag were the same as commercial salad mix bags. The bags were filled with fresh spring mix and placed in the refrigerated room (35° F., 50% R.H.). The samples were observed at 4 hours, 24 hours, 3 days, and 7 days for fog.

Results are shown in the Table below.

| | | | | | | | | | | | 36 | |
|---|---|---|---|---|---|---|---|---|---|---|---|---|
| | | | | | | | | 100 | 120 | 200 | OPET- | 36 |
| | | | | | | | | GA | GA | GA | 100 | OPET- |
| Test | | Units | Variable 1 | Variable 2 | Variable 3 | Variable 4 | OPLA | PLA | PLA | PLA | PLA | OPLA |
| OTR | per | cc/24 hrs | 476.10 | 498.29 | 475.34 | 442.93 | 678.71 | 611.15 | 564.13 | 268.81 | 109.63 | 108.5 |
| (50% | m² | | | | | | | | | | | |
| R.H. | per | cc/24 hrs | 30.72 | 32.15 | 30.67 | 28.58 | 43.79 | 39.43 | 36.4 | 17.34 | 7.07 | 7.00 |
| 73 F.) | 100 m² | | | | | | | | | | | |
| MVTR | per | gms/24 hrs | 8.49 | 8.05 | 6.70 | 6.21 | 197.14 | 173.55 | 145.68 | 90.10 | 36.91 | 40.77 |
| (100 F. | m² | | | | | | | | | | | |
| 90% | per | gms/24 hrs | 0.55 | 0.52 | 0.43 | 0.43 | 12.72 | 11.2 | 9.4 | 5.81 | 2.36 | 2.63 |
| R.H) | 100 m² | | | | | | | | | | | |

The amount of fog present was dependent on the surface area of the sample. The salad bags had the same level of severity of fog as the beaker samples, but cleared at an accelerated rate due to the different surface area to water ratios. The beakers had roughly 10 times less surface area than the bags (7 in² versus 81 in²), but approximately 10 times more the amount of water (200 mL versus 20 mL).

At four hours, the beaker samples of PLA, OPP-PLA laminations, and OPET-PLA laminations had the same amount of fog. However, the PLA cleared faster than the laminations (clear within three to seven days). The laminations still had fog after one week, but the OPET-PLA was clearer than the OPP-PLA. The OPET-PLA laminations had less fog apparent, mostly in the form of water droplets.

To reduce the amount of fog in the OPP-PLA samples, a comparison sample (not of OPP-PLA) was created with an anti-fog coating and another sample (of OPP-PLA) was made with tiny holes to increase the MVTR. These samples were successful at reducing the amount of fog in the coated area. The anti-fog coated area showed no fog during the entire seven day testing period. In the perforated file, the perforations were noticed after four hours, with a ring of clear film around each perforation.

In addition, the PLA samples showed a noticeable reduction in fog compared to the uncoated control areas of the anti-fog coated bag after seven days. The OPET-PLA and OPP-PLA laminations were mostly clear with a few water droplets, whereas the control area displayed a high amount of dense fog. In addition, the monolayer PLA samples equated to the anti-fog characteristics seen in the coated area of the bag.

Generally, the salad bag prototypes mimicked the results seen in the beaker test, except that the fog disappeared at an accelerated rate due to the increased surface area. The PLA salad bags were clear from fog within approximately 24 hours, the OPET-PLA laminations were clear within four to five days, and the OPP-PLA laminations had some fog remaining after one week. The PLA and PLA laminated salad bags showed an improvement in anti-fog characteristics over the non-PLA control salad bag with no anti-fog coating. After one week, the anti-fog coating was better at fog reduction than the OPP-PLA and OPET-PLA laminations and comparable to the PLA salad bags.

In sum, the MVTR was directly proportional to the rate at which the fog disappeared. The higher the MVTR (i.e. PLA), the faster the fog disappeared. Anti-fog coating and perforations in the film were both effective ways to decrease the amount of fog or increase the rate the fog disappeared. In addition, it was observed that the PLA salad bags began to show signs of lettuce wilting after roughly one week past the stamped ‘use by’ date.

### EXAMPLE 2

Two types of PLA were used to compare anti-fog characteristics. The first type was 48 GA OPP-100 GA PLA laminated film (OPP-PLA film) and the second type was 100 GA PLA (PLA film). In the first type, a commercially available anti-fog coating was applied to half the sample.

Six beakers were prepared, three using the OPP-PLA film samples with ½ the sample having an anti-fog coating as described above and three using the PLA film samples. The anti-fog coating and uncoated interface of the OPP-PLA sample was centered over the beaker. The water temperatures of the beakers were varied with target water temperatures of 34° F., 54° F., and 72° F. The beakers were filled with water at or close to the target temperatures and the samples were placed on the beakers with rubber bands. The resulting beakers were placed on a red tray in the refrigerated room and pictures were taken at 4 hours, 24 hours, 3 days, and 7 days for observation.

TABLE 1
Sample Identification

| | Temperature | | |
|---|---|---|---|
| PLA | 73° F. | 34° F. | 53° F. |
| 100 GA | 1 | 2 | 3 |
| 48 OPP - 100 GA PLA | 4 | 5 | 6 |

Table 2 shows the actual water temperatures of the beakers.

TABLE 2
Actual Water Temperatures

| | Sample | | | | | |
|---|---|---|---|---|---|---|
| | 1 | 2 | 3 | 4 | 5 | 6 |
| Water | 73.2° F. | 33.2° F. | 54.4° F. | 73° F. | 33.2° F. | 53.6° F. |
| Temperature | | | | | | |

At four hours, the cold water samples (Samples 2 and 5) had no fog. The other samples displayed a large amount of very dense fog. Sample 3 had small areas of clear film near the edge of the beaker. Samples 4 and 6 showed that the anti-fog coating was effective. Sample 6 had no fog in the coated region, while Sample 4 had a very small line of fog through the coated region.

At twenty-four hours, the cold water samples continued to have no fog. Samples 1 and 3 had a significantly reduced amount of fog from four hours. Sample 3 had roughly half the amount of fog than Sample 1. Both Samples 1 and 3 showed a less dense fog with water droplets more apparent. Samples 4 and 6 still displayed a large amount of dense fog that was difficult to see through. Sample 4 had a small ring of clear film near the edge of the beaker and Sample 6 showed a reduced amount of fog from 4 hours to 24 hours by about a third. In general the samples with the PLA and colder water cleared up faster demonstrating that the amount of fog and the rate it disappeared was dependent on both the water temperature and the material.

At three days, Samples 2 and 5 still had no fog. In addition, Sample 3 had no fog or water droplets apparent. Sample 1 had a very small amount of fog, mostly in the form of a small region of water droplets. In Sample 4, the region of fog in the anti-fog coating area was gone, however, in the non-coated region, there was little to no change from 24 hours. Sample 6 did not show a change in fog density from 24 hours to 3 days; however, a reduction in fog area was noticed.

At seven days, Sample 4 was the only remaining sample with fog. The density of the fog had not really changed from the 3 day sample; however the area of the fog was greatly reduced.

In summary, the amount of fog was proportional to the water temperature—less fog was present at colder temperatures and at a water temperature of 33° F., no fog was apparent on either film. The fog cleared up faster on the PLA (roughly 3-4 days) than the OPP-PLA (greater than one week). The anti-fog coating greatly reduced fog at all temperatures, although the 73° F. sample still had some fog apparent on the anti-fog coating.

### EXAMPLE 3

Salad bags were made from an OPP-PLA laminated film and from a monolayer PLA film. The OPP-PLA bags were composed of OPP and PLA film bag having an anti-fog coating in a 5×7 in² area on the front of the bag. Microperforations were added to some of the bags in the same area as the anti-fog coating of the OPP-PLA laminated film. The bags were perforated with 20, 40, or 80 perforations.

In summary, there was little reduction in the overall anti-fog characteristics of the OPP-PLA bags with 20 perforations. At 40 perforations, the fog was reduced and the hole patterns apparent; however, the final seven day pictures yielded approximately the same results as the unperforated OPP-PLA bags. The greatest difference in anti-fog characteristics was noticed at 80 perforations. At 24 hours, the 80 perforated bag equated to the unperforated seven day OPP-PLA bag; at seven days, it is equivalent to the monolayer PLA bags (completely clear of fog).

### EXAMPLE 4

Additional tests were performed to compare bags with micro-perforations and bags without perforations. Eight samples of film including perforated and non-perforated film were made into salad bags. The bags were made using an impulse sealer. The dimensions of the bags were the same as a commercially available salad mix bag 9″×9″. The bags were filled with fresh spring mix and placed in the refrigerated room (35° F., 50% R.H.). Observations were made at 4 hours, 24 hours, 3 days, 7 days, and 2 weeks.

| Sample | Film | Perforations | Caliper (mm) |
|---|---|---|---|
| 1 | 48 OPP - 100 PLA | 0 | 1.66 |
| 2 | 48 OPP - 100 PLA | 5 | 1.66 |
| 3 | 48 OPP - 100 PLA | 10 | 1.66 |
| 4 | 48 OPP - 100 PLA | 15 | 1.66 |
| 5 | Control | 0 | 2.3 |
| 6 | 36 OPET - 100 PLA | 0 | 1.55 |
| 7 | 70 OPP - 100 PLA | 0 | 1.84 |
| 8 | 70 OPP - 100 PLA | 10 | 1.84 |

Perforated PLA films generally had worse anti-fog characteristics than bags without the micro-perforations. However, the more perforations a bag had, the better the anti-fog. Moreover, there be an optimal amount of micro-perforations as is within the skill of the art to determine.

Perforated PLA films caused the lettuce to wilt and build up a brown liquid quicker than non-perforated bags. Therefore, generally perforated PLA films did not increase shelf-life or perceived freshness. However, micro-perforations may be used to obtain optimal characteristics. The OTR and MVTR conditions were the same as Example 1.

| | | | Perceived Freshness | | | | Anti-Fog | | |
|---|---|---|---|---|---|---|---|---|---|
| | MVTR | OTR | 4 | 1 | 2 | 3 | | 1 | 2 |
| Sample | 100 in² | 100 in² | Days | week | weeks | Weeks | 4 Days | week | weeks |
| 1 | 0.6 | 31 | Fresh | Fresh | Fresh | Soggy | Clear | Clear | Clear |
| 2 | 0.6* | 94* | Fresh | Fresh | Fresh | Soggy | Patches | Patches | Patches |
| 3 | 0.6* | 157* | Fresh | Fresh | Soggy | Soggy | Patches | Patches | Patches |
| 4 | 0.7* | 220* | Fresh | Fresh | Soggy | Soggy | Patches | Clear | Clear |
| 5 | 12.7 | 44 | Fresh | Soggy | Soggy | Soggy | Clear | Clear | Clear |
| 6 | 2.4 | 7 | Fresh | Fresh | Fresh | Soggy | Clear | Clear | Clear |
| 7 | 0.4 | 31 | Fresh | Fresh | Fresh | Soggy | Clear | Clear | Clear |
| 8 | 0.5* | 157* | Fresh | Fresh | Soggy | Soggy | Fog | Patches | Patches |

*Values normalized from test run per perforation
Soggy: Lettuce was soggy or wet, some brown liquid may be apparent.
Fresh: Lettuce had good color, edible from customer's view.
Clear: Bag is free from fog and water droplets
Patches: Occasional areas of fog or water droplets
Fog: Large areas of fog or water droplets

### EXAMPLE 5

Sample salad bags were made of monolayer PLA (100, 120, and 200 gauge), 36 OPET-100 PLA, and 48 OPP-100 PLA to observe the amount of water loss over time and the correlation to MVTR. Sample bags were filled with spring mix (expiration date June 19^{th}) and kept in a refrigerated room (35° F., 50% RH). Weight measurements were taken and an additional spring mix bag was tested for comparison.

Total Water
Loss

| PLA | grams | percent |
|---|---|---|
| Control | 1.5 | 1% |
| 100 | 22.5 | 15% |
| 120 | 21.5 | 14% |
| 200 | 15.5 | 9% |
| OPET - 100 | 7.5 | 5% |
| PLA | | |
| OPP - 100 PLA | 1.5 | 1% |

The amount of overall water loss was directly proportional to MVTR. The monolayer PLA samples lost the most water and had the highest MVTR. The sample most similar to the control bag is the 48 OPP-100 PLA (in both amount of water lost and fog characteristics). After one week, PLA samples began to show fog on outside of bag. After two weeks, the control was beginning to leak.

The PLA sample thickness, MVTR, total water loss, perceived freshness and anti-fog are compared in the table below. The total water loss in grams correlates to the MVTR; the higher the amount of water loss, the higher the MVTR. MVTR also correlates to perceived freshness and anti-fog. The PLA samples with a better perceived freshness have a lower MVTR value, but a poorer anti-fog rating and visa versa. In the assessment of fogging, it was discovered that unexpected shelf-life was obtained with the use of PLA films. This was not expected at the beginning of these tests.

| | Caliper | MVTR | | Perceived Freshness | | | Anti-Fog | | |
|---|---|---|---|---|---|---|---|---|---|
| PLA | Mils | per m² | per 100 in² | 4 days | 1 week | 2 weeks | 4 days | 1 week | 2 weeks |
| Control | 2.28 | 3 | 0.2 | Fresh | Soggy | Soggy | Fog | Patches | Patches |
| PE/PE | | | | | | | | | |
| 100 | 1.18 | 174 | 11 | Wilted | Wilted | Wilted | Clear | Clear | Clear |
| 120 | 1.26 | 146 | 9 | Wilted | Wilted | Wilted | Clear | Clear | Clear |
| 200 | 2.09 | 90 | 6 | Fresh | Soggy | Soggy | Clear | Clear | Clear |
| 36 OPET- | 1.55 | 37 | 2 | Fresh | Fresh | Soggy | Patches | Clear | Clear |
| 100 PLA | | | | | | | | | |
| 48 OPP- | 1.66 | 8 | 1 | Fresh | Fresh | Soggy | Fog | Patches | Patches |
| 100 PLA | | | | | | | | | |

Wilted: Lettuce is somewhat dry and wilted
Soggy: Lettuce is soggy or wet, some brown liquid might be apparent
Fresh: Lettuce has good color, edible from customer's view
Clear: Bag is free from fog and water droplets
Patches: Occasional areas of fog or water droplets
Fog: Large areas of fog or water droplets

In addition, PLA O₂ levels tests were done.

| PLA | O₂ Level % | OTR |
|---|---|---|
| Control | 6 | 100 |
| 100 PLA | 18 | 39 |
| 120 PLA | 5 | 36 |
| 200 PLA | 16 | 17 |
| 36 OPET - 100 PLA | 0.3 | 7 |
| 48 OPP - 100 PLA | 1 | 31 |

Microbial tests taken on July 2 showed that OPP-PLA and OPET-PLA had fewer microorganisms than the control store sample

| | PCA | | PDA (mold | PDA, |
|---|---|---|---|---|
| | (bacteria | Anaerobic | and yeast | surface |
| Sample | Count) | media | count) | plate |
| 48 OPP - 100 PLA | 235 × 10⁵ | 64 × 10³ | 53 × 10² | 6 × 10² |
| 36 PET - 100 PLA | 190 × 10⁵ | 86 × 10³ | 72 × 10² | 11 × 10² |
| Control, Expiration | 280 × 10⁵ | 20 × 10⁴ | 148 × 10³ | 16 × 10³ |
| June 20 | | | | |

While the various aspects of the invention have been described in conjunction with the example structures and methods described above, various alternatives, modifications, variations, improvements and/or substantial equivalents, whether known or may be presently unforeseen, may become apparent to those having at least ordinary skill in the art. Accordingly, the example structures and methods, as set forth above, are intended to be illustrative of the invention, not limiting it. Various changes may be made without departing from the spirit and scope of the invention. Therefore, the invention is intended to embrace all known or later developed alternatives, modifications, variations, improvements and/or substantial equivalents

1. A breathable, extended shelf-life, package for storing fresh produce or plants, the package comprising one or more film layers, wherein at least one layer comprises a polylactic acid film layer.

2. The package of claim 1 wherein the package is transparent.

3. The package of claim 1 wherein the package prevents or reduces fogging.

4. The package of claim 1 wherein one or more of the film layers is heat sealable

5. The package of claim 1 further comprising micro-perforations.

6. The package of claim 1 wherein the polylactic acid film layer is about 70 to about 200 GA.

7. The package of claim 1 wherein the MVTR is about 5 to about 12 gms/24 hrs per 100 in² at 100° F., 90% R.H.

8. The package of claim 1 wherein the OTR is about 15 to about 41 cc/24 hrs per 100 in² at 73° F., 50% R.H.

9. A breathable, extended shelf-life, package for storing fresh produce or plants, the package comprising two or more film layers wherein at least one layer comprises a polylactic acid film layer and at least one other polymer layer comprises a polyolefin film layer or a polyester film layer other than a polylactic acid film layer.

10. The package of claim 9 wherein the at least one other polymer layer is oriented polyethylene terephthalate, oriented polypropylene, or a polyethylene.

11. The package of claim 9 wherein the MVTR is about 0.5 to about 4 gms/24 hrs per 100 in² at 100° F., 90% R.H.

12. The package of claim 9 wherein the OTR is about 6 to about 9 cc/24 hrs per 100 in² at 73° F., 50% R.H.

13. The package of claim 9 wherein the MVTR is about 0.1 to about 3 gms/24 hrs per 100 in² at 100° F., 90% R.H.

14. The package of claim 9 wherein the OTR is about 25 to about 35 cc/24 hrs per 100 in² at 73° F., 50% R.H.

15. The package of claim 9 comprising the polyolefin 36 OPET or the polyolefin 48 OPP.

16. The package of claim 9 wherein at least two of the layers are laminated.

17. The package of claim 9 wherein the package is transparent.

18. The package of claim 9 wherein the package prevents or reduces fogging during refrigeration.

19. The package of claim 9 wherein one or more of the film layers is heat sealable

20. The package of claim 9 further comprising micro-perforations.

21. The package of claim 9 wherein the PLA layer is about 70 to about 200 GA.

22. A method of making an anti-fog package comprising adhering a polylactic acid film layer to a polyolefin film layer or a polyester film layer other than a polylactic acid film layer and then forming the package.

23. The method of claim 22 comprising co-extruding a polylactic acid film layer and a polyolefin film layer or a polyester film layer other than a polylactic acid film layer.

24. The method of claim 22 comprising laminating a polylactic acid film layer to a polyolefin film layer or a polyester film layer other than a polylactic acid film layer.

25. The method of claim 22 further comprising irradiating the package.

26. The package of claim 1 further comprising at least one reclosable seal, a press-to-close seal, a zipper seal, or combination thereof.

27. The package of claim 9 further comprising at least one reclosable seal, a press-to-close seal, a zipper seal, or combination thereof.

28. The package of claim 1 wherein the package is flexible.

29. The package of claim 9 wherein the package is flexible.
